(19) United States
(12) Patent Application Publication
(10) Pub. No.: US 2006/0202627 A1
(43) Pub. Date: Sep. 14, 2006

(54) Ceramic arctubes for discharge lamps

(75) Inventors: David C. Dudik, South Euclid, OH (US); Gary R. Allen, Chesterland, OH (US); Viktor K. Varga, Solon, OH (US); Alan G. Chalmers, Akron, OH (US)

Correspondence Address: PEARNE & GORDON LLP, 1801 EAST 9TH STREET, SUITE 1200, CLEVELAND, OH, 44114-3108, US

(73) Assignee: General Electric Company

(21) Appl. No.: 11/311,118

(22) Filed: Dec. 19, 2005

Related U.S. Application Data
(60) Provisional application No. 60/659,950, filed on Mar. 9, 2005.

(51) Int. Cl. H01J 61/30; H01J 17/16; H01J 17/20

(52) U.S. Cl. 313/634; 313/573; 313/493

(57) ABSTRACT

A ceramic arctube for use in a high intensity discharge lamp. The arctube includes a ceramic light transmitting tube which surrounds the arc. The light transmitting tube has two or more features selected from the group consisting of (a) an inner diameter less than 2.6 mm, (b) a wall thickness of less than 1.4 mm, (c) an average grain size of greater than 20 microns or less than 5 microns or real in-line transmission (RIT) greater than 20%, and (d) an inner surface or outer surface having an Ra value less than 100 nm. These features lead to a smaller apparent size of the arc source and less scattering of light, resulting in improved performance of the arctube in a reflector lamp.

This application claims the benefit of U.S. Provisional Patent App. No. 60/659,950 filed Mar. 9, 2005, the contents of which are incorporated herein by reference.

### FIELD OF THE INVENTION

The present invention relates generally to ceramic arctube discharge lamps and more particularly to improved ceramic arctubes for high intensity discharge lamps.

### DESCRIPTION OF RELATED ART

Traditionally, quartz has been the material used to make arctubes for high intensity discharge (HID) lamps. Quartz has a low refractive index of 1.46, typically has a smooth surface, and is completely vitreous with virtually no scattering of light as the light passes through the material, as a result of which quartz transmits a very clear undistorted image of the arc with consequently good performance in a reflector lamp. Compared to a quartz arctube, a ceramic arctube (a) will operate at higher temperature, which results in higher vapor pressure enabling increased efficiency, better color, and higher performance and (b) has increased physical strength and resistance to chemical corrosion, which contribute to a longer operating life. However, ceramic has optical properties which are inferior to quartz: common optical ceramics alumina and yttrium-aluminum garnet (YAG) have refractive indices of 1.77 and 1.84, respectively, resulting in increased Fresnel reflections at both the inside and outside surfaces of the arctube; and polycrystalline ceramics have light scattering from the ceramic surface due in part to surface roughness and finite volume scattering due to residual porosity and grain boundary scattering. It is known in the art that the translucency of polycrystalline alumina (PCA) is highly dependent on grain size.

There is a need for an improved ceramic arctube so that the ceramic arctube can provide improved optical performance, preferably equivalent to a quartz arctube, in discharge lamps such as automotive high intensity discharge headlamps.

### SUMMARY OF THE INVENTION

A ceramic arctube is provided for use in a high intensity discharge lamp. The arctube includes a ceramic light transmitting tube and a pair of spaced apart electrodes. The light transmitting tube has two or more features selected from the group consisting of (a) an inner diameter less than 2.6 mm, (b) a wall thickness of less than 1.4 mm, (c) an average grain size of greater than 20 microns or less than 5 microns or real in-line transmission (RIT) greater than 20%, and (d) an inner surface or outer surface having an Ra value less than 100 nm.

### BRIEF DESCRIPTION OF THE DRAWINGS

FIG. 1 is a diagrammatic or schematic cross sectional view of a reflector lamp or headlamp according to the invention.

FIG. 2 is a partially schematic cross sectional view of a ceramic arctube according to the invention.

FIG. 3a is a contour plot of the full beam lumens of a headlamp system with a typical translucent PCA arctube with grain size of ˜25 microns as a function of arctube diameter and arctube wall thickness shown as a percentage of a quartz arctube full beam lumens in the same system.

FIG. 3b is a contour plot of the MBCP of a headlamp system with a PCA arctube as a function of arctube diameter and arctube wall thickness shown as a percentage of a quartz arctube MBCP in the same system.

FIG. 4 is a contour plot of the MBCP of a headlamp system with a polished YAG arctube as a function of arctube diameter and arctube wall thickness shown as a percentage of a quartz arctube MBCP in the same system.

FIG. 5 is a contour plot of the MBCP of a headlamp system with a polished PCA arctube as a function of arctube diameter and arctube wall thickness shown as a percentage of a quartz arctube MBCP in the same system.

FIG. 6 is a plot of in-line transmission vs. grain size for PCA.

FIG. 7 is a contour plot of the MBCP of a headlamp system with a PCA arctube with average grain size of ˜50 microns as a function of arctube diameter and arctube wall thickness shown as a percentage of a quartz arctube MBCP in the same system.

FIG. 8 is a contour plot of the MBCP of a headlamp system with a polished sapphire arctube as a function of arctube diameter and arctube wall thickness shown as a percentage of a quartz arctube MBCP in the same system.

### DETAILED DESCRIPTION OF THE PREFERRED EMBODIMENTS OF THE INVENTION

As used herein, when a range such as 5-25 or 5 to 25 is given, this means preferably at least 5 and, separately and independently, preferably not more than 25.

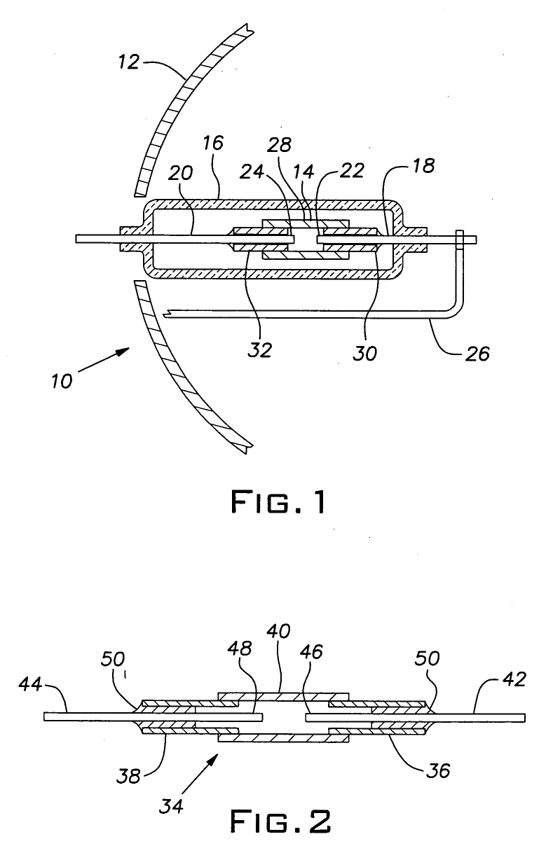

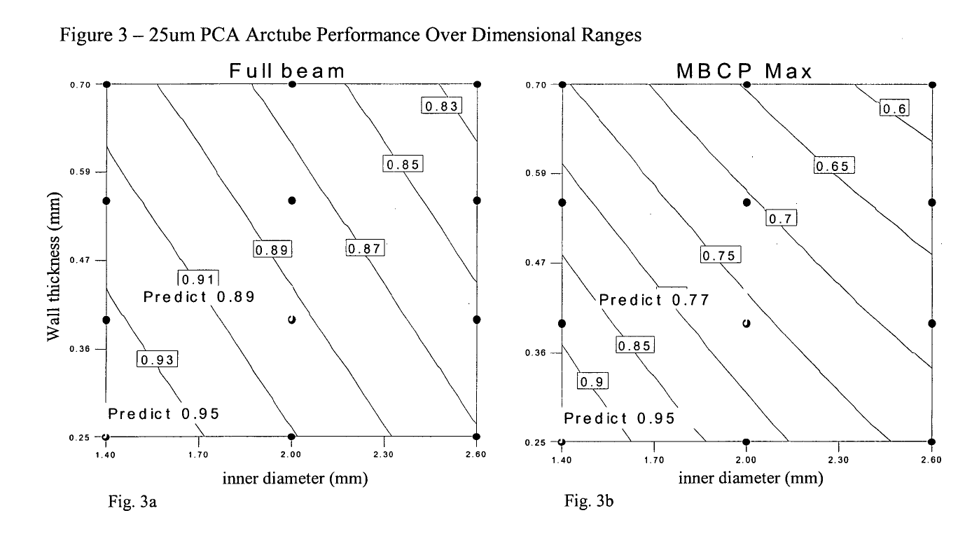

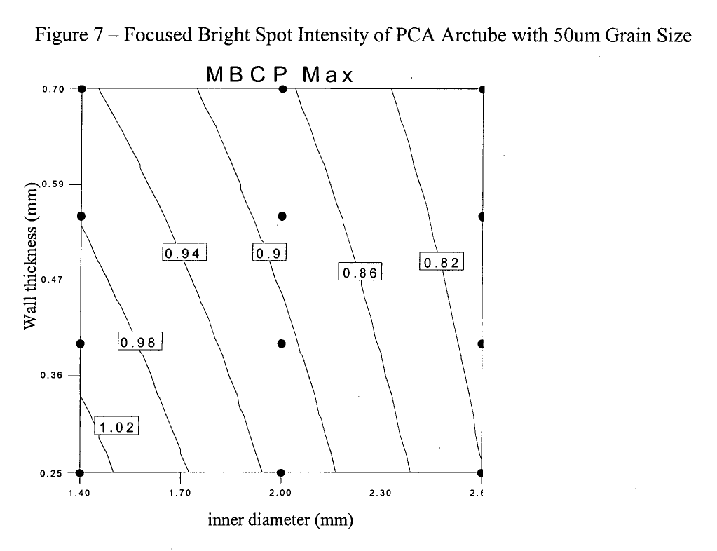

With reference to FIG. 1, there is shown a reflector lamp or headlamp 10 comprising a reflector 12 as known in the art, which may be a parabolic, or elliptical, or free-form, or non-imaging reflector or any other optical system, and a ceramic arctube 14 which may be inside a glass shroud 16. Lamp 10 also includes current conductors 18, 20 which are electrically connected to the electrodes 22, 24. Current conductor 18 is fixed to a bent end portion of the lead support 26 connected to the base in a conventional manner. Arctube 14 comprises a ceramic light transmitting tube 28, preferably cylindrical, but may be a hollow vessel of any elongated shape which is open at both ends, said openings being at least partially plugged by first leg 30 and second leg 32, both legs preferably being cylindrical. Legs 30, 32 can be ceramic but may be other materials such as molybdenum, or other refractory metals or their alloys, or combinations of ceramic and metal such as cermets. Current conductors 18, 20 can have portions made of tungsten, molybdenum, niobium and/or other materials as known in the art. FIG. 1 is schematic and, other than regarding light transmitting tube 28, illustrates conventional and known reflector lamps, shrouds, ceramic arctubes and related structures, such as known in US 2005/0007020 A1, US 2004/0174121 A1, U.S. Pat. No. 5,998,915, US 2004/0108814 A1, U.S. Pat. No. 6,404,129 B1 and WO 2004/051700 A2, the contents of which are incorporated by reference. The legs 30, 32, and current conductors 18, 20 can be of different materials, parts, constructions and arrangements and may include additional parts and features and can be sealed in different manners, all as known in the art. For example, legs 30, 32 can be made of molybdenum (see FIG. 3 of US 2005/0007020 A1) or can include a molybdenum pipe (see FIGS. 7, 9 and 13 of US 2005/0007020 A1). The present invention is directed to the tube 28 and its diameter, thickness, ceramic material, and surface smoothness.

The ceramic arctube 34 of FIG. 2 can be used in the reflector lamp 10. Arctube 34 has a ceramic light transmitting tube 40 corresponding to light transmitting tube 28, a first leg 36 corresponding to first leg 30, a second leg 38 corresponding to second leg 32, current conductors 42, 44 corresponding to current conductors 18, 20, and electrodes 46, 48 corresponding to electrodes 22, 24. As known in the art, ceramic sealing compound 50 can be used to seal the current conductors inside the legs. Tubes 28 and 40 are preferably polycrystalline alumina (PCA) or a highly dense, generally isotropic polycrystalline ceramic, such as yttrium-aluminum garnet (YAG), yttria, spinel, or AlON, or a single crystal ceramic such as sapphire or single crystal YAG.

With respect to light transmitting tube 28 and 40, small wall thickness and small inside diameter reduce the amount of scattering and the effective size of the light source, respectively, and accordingly improve the performance of the invented ceramic arctube in a reflector lamp. For each 0.2 mm reduction in light transmitting tube diameter, the focused bright spot intensity of an automotive headlamp is improved about 3%, and full beam output about 1% in comparison to a standard quartz lamp in a standard optical system. FIGS. 3a and 3b show the relationship between arctube diameter and arctube wall thickness for a PCA arctube compared to a quartz arctube in a standard optical system. The inner diameter of tubes 28 and 40 should be as small as allowed by thermal and stress design considerations, and is preferably less than 3.0, 2.8, 2.6, 2.5, 2.4, 2.3, 2.2, 2.1, 2, 1.9, 1.8, 1.7, 1.6, 1.5, 1.4, 1.3, 1.2, 1.1, 1, mm and preferably at least 0.8, 0.9 or 1, mm.

The wall thickness of tubes 28, 40 should be as small as allowed by thermal and stress design consideration, and the wall thickness of tubes 28, 40 is preferably less than 1.5, 1.4, 1.3, 1.2, 1.1, 1, 0.9, 0.8, 0.7, 0.6, 0.5, 0.4, 0.3, mm and preferably at least 0.25 mm. The arc gap can, for example, be 4.2 mm or other distances as known in the art. Combining the benefits of smaller wall thickness and inner diameter (and/or with the other improvements disclosed herein) can result in a ceramic arctube that has equivalent (at least 90%, preferably at least 92%, 94%, 95%, 96%, 98%, 99%, or more preferably 100%) of (a) the focused bright spot intensity defined by the ECE Regulation 98 spec points 3, and 7 requiring 20 lux minimum at a distance of 25 m for a driving beam in the main punch area of the beam (hereinafter and in the claims “focused bright spot intensity”), and (b) total beam output, i.e. the total lumens from the headlamp system projected onto the road, compared to a standard quartz HID automotive headlamp according to European ECE Regulation 99, Lamp Model No. D2 having nominal dimensions of 2.6 mm inner diameter, 1.8 mm wall thickness and 4.2 mm arc gap.

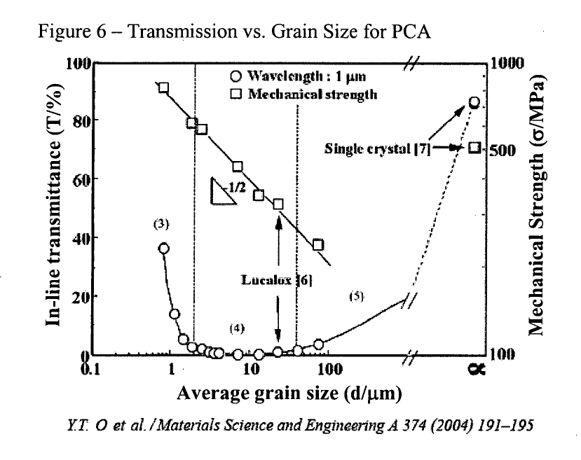

Polycrystalline ceramic materials inherently possess a large number of volume scattering sites, which can come from residual porosity and grain boundaries. The more volume scattering sites, the worse the image transmission of the arc through the ceramic, which will detrimentally impact the performance of a ceramic arctube in an optical system. It is also known in the art that PCA transmission improves with very small grains, smaller than about 5 micron, and large grains as they approach single crystal. The worst PCA transmission occurs in the range of grain sizes of about 5-20 microns, shown in FIG. 6, a plot of transmission vs. grain size in microns for PCA. Typically, translucent PCA has an average grain size of 20-40 um, with individual grains varying up to 60 um in size. Volume scattering in PCA can be reduced by using a ceramic with average grain size greater than 20, 40, 50, 80, 100, or 130, microns or below 5 microns. As grain size increases, the number of volume scattering sites decreases, the cross-sectional area of grain boundaries decreases and the bulk of the ceramic becomes less scattering. For smaller grain sizes, the effect of refraction at the grain boundaries is reduced, and the volume scattering decreases. It is well known in the art that the grain size of polycrystalline ceramics can be increased by additional heat treatments at or near the sintering temperature, or varying the dopants of the alumina. Additional heat treatments at the sintering temperature can increase the average grain size of PCA from 25 um to about 100 or 130 um, with a homogenous size distribution and no exaggerated grain growth. FIG. 7 shows the MBCP performance of a PCA arctube with average grain size of 50 um. Compared with FIG. 3b, this corresponds to a 15% gain in focused bright spot intensity and a 5% gain in full beam output for automotive headlamp beam pattern performance compared to standard PCA for the typical case of a PCA tube with ID=2.0 mm and wall thickness=0.4 mm in a typical headlamp reflector system. The average grain size can also be created less than 5 micron by various processing techniques that are known in the art. Preferably the grain size or average grain size of the polycrystalline alumina PCA ceramic in the tubes 28, 40 is smaller than 5 microns, more preferably, smaller than 3 microns, more preferably smaller than 1 micron or greater than 20 microns, more preferably greater than 30, 40, 50, 60, 70, 80, 90, 100, 110, 120, microns.

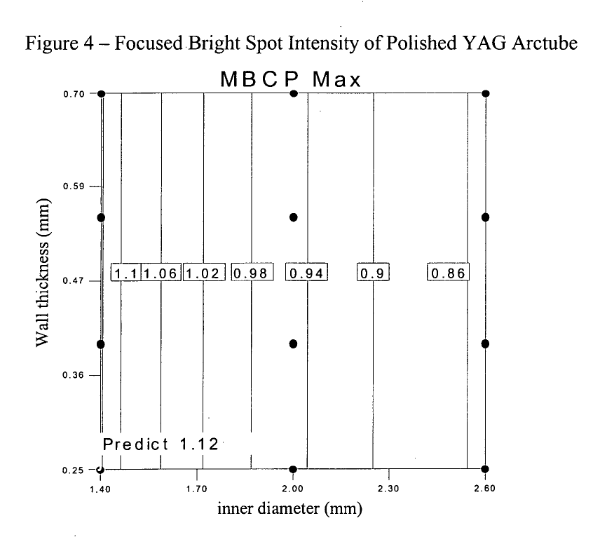

The choice of a highly dense polycrystalline ceramic arctube material with isotropic physical properties, such as YAG (yttrium-aluminum garnet), spinel (MgAl₂O₄), or yttria (Y₂O₃), can also reduce the scattering in the volume of the ceramic and accordingly these materials can also be used for the arctube. In alumina, volume scattering is partially driven by birefringence of light between different material refractive index crystallographic directions in a randomly oriented grain structure. Using a ceramic material with near-constant or constant index in all directions can reduce this cause of volume scattering. If a high-density ceramic is fabricated, the use of polycrystalline YAG typically results in even less scattering than grain-size controlled PCA. This can result in real in-line transmission measurements (RIT) of greater than 20% (which is preferred), where RIT is measured over an angular aperture of ˜0.5° for a sample thickness of 0.8 mm with a monochromatic wavelength of incoming light. The RIT for a preferred highly dense polycrystalline ceramic arctube material with isotropic physical properties for use in the present invention is preferably greater than 20%, more preferably greater than 30%, 40%, 50%, 60%, 70%, or 80%. The increased benefits of using polycrystalline YAG with low volume scattering in headlamp applications is shown in FIG. 4, which shows the performance of a polished YAG arctube of varying dimensions in a headlamp system as a percentage of the performance of a quartz arctube in the same system.

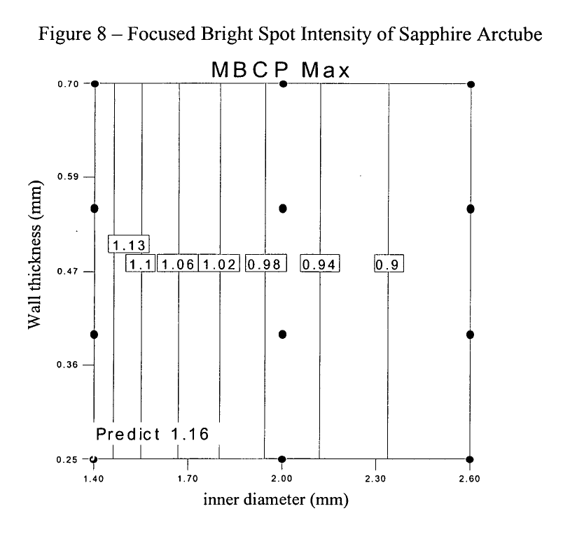

An arctube made from a single crystal ceramic material can be useful for a light transmitting arctube material, as it would contain virtually no volume scattering sites, being completely dense, and containing no grain boundaries. Any single crystal ceramic that is transmissive to visible light, such as sapphire or single crystal YAG, can be used as a ceramic light-transmitting arctube material. It has been shown that gains of ˜20% in MBCP over a translucent PCA arctube can be achieved using a sapphire ceramic arctube. FIG. 8 shows the MBCP performance of a polished sapphire arctube of varying dimensions in a headlamp system as a percentage of a quartz arctube performance in the same system.

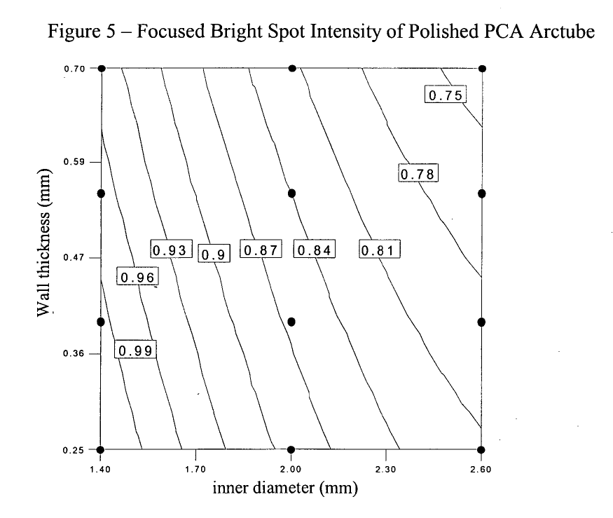

The surface roughness of tubes 28, 40 where the light goes through (both inner surface and outer surface) is caused by the polycrystalline substructure of the ceramic (which can include random orientation of grains at the surface) and surface figure artifacts from forming and processing, and surface roughness can cause light scattering at the surface which distorts the arc image, and is detrimental to performance. The surface roughness can be described by the Ra value, an arithmetic mean measurement of the height of the surface features. It is desirable to reduce the Ra value, thus reducing the surface roughness, thus reducing surface scattering, and improving performance. The Ra value of the inner and outer surfaces of ceramic tubes 28 and 40 where the light passes through on its way out of the arctube, is preferably less than 500, 400, 300, 200, 150, 120, 110, 100, 80, 75, 70, 60, 50, 40, 30, 25, 20, 10, or 5, nm. Surface profilometry measurements and transmission measurements were taken from YAG disks polished to different surface roughness levels, which showed that a significant loss in transmission (˜10%) is prevented with roughness levels below Ra 75 nm. The measurements were: roughness levels of Ra 0.78 nm, 9.60 nm, 68.11 nm, 136.47 nm and 1171.17 nm had transmission percentages of 84.22%, 83.88%, 76.02%, 63.98% and 1.18%, respectively. Photometric measurements support this, and show that polishing both the inside and outside surfaces to Ra <100 nm can improve the collected efficiency, i.e., the light collected from an optical system using a standard light source inside a ceramic arctube which focuses the light into a limiting etendue measurement system of the arctube by 5-20% over a wide etendue range compared with an unpolished surface having Ra >300 nm. Optical raytrace modeling shows that the improvement translates into gains of 5-10% in focused bright spot intensity and 2-4% in full beam output for an automotive HID headlamp application for the typical case of a PCA tube with ID=2.0 mm and wall thickness=0.4 mm in a typical headlamp reflector system. FIG. 5 shows the MBCP performance of a polished PCA arctube in comparison to a quartz arctube in a standard headlamp system.

The surfaces of tubes 28 and 40 can be smoothed or polished, and the Ra values reduced, by a variety of mechanical, chemical, and other polishing methods, such as mechanical polishing using abrasive particles that are brought into forceful contact with the surface to be polished, or chemical polishing using acids or solvents that can dissolve or remove surface defects. A useful mechanical polishing method for polishing hard ceramics, such as PCA, uses abrasive magnetic particles suspended in a solution that is rotated using a varying magnetic field. This is extremely useful for polishing the inner surfaces of small or complex shapes, since the force bringing the abrasive particles in contact with the surface is applied magnetically, with no external physical contact required. Magnetic polishing is known in the art; see Yamaguchi and Shinmura, “Study on a New Internal Finishing Process by the Application of Magnetic Abrasive Machining”, Trans. Jpn. Soc. Mech. Eng., Vol. 60, No. 578, 1994. If the ceramic forming/processing routes taken to fabricate the ceramic arctube use a free surface or otherwise highly smooth surface to form the inner surface of the arctube, the inner surface of the ceramic arctube may be imparted with a Ra of less than 100 nm during fabrication. This would be useful as methods to polish the external surface of a ceramic arctube are simpler and more flexible.

The ceramic arctube of the present invention is particularly useful in an automotive HID headlamp, and also in video projection lamps, medical lamps, display lighting, fiber-optic illumination, and also other applications where scattered light is undesirable and a well-controlled beam pattern is desired, or in an application where the size or weight or cost of the optical system can be reduced by a reduction in the effective size of the light source.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A ceramic arctube for use in a high intensity discharge lamp, said arctube comprising a polycrystalline alumina ceramic light transmitting tube and a pair of spaced apart electrodes, said ceramic light transmitting tube having two or more features selected from the group consisting of (a) an inner diameter less than 2.6 mm, (b) a wall thickness of less than 1.4 mm, (c) an average grain size of greater than 20 microns or less than 5 microns, and (d) an inner surface or outer surface having an Ra value less than 100 nm.

2. The arctube of claim 1, said light transmitting tube having 3 or more features selected from said group.

3. The arctube of claim 1, said light transmitting tube having all 4 features of said group.

4. The arctube of claim 1, said arctube further comprising a first leg at least partially plugging a first end of said light transmitting tube and a second leg at least partially plugging a second end of said light transmitting tube.

5. The arctube of claim 1, said arctube providing at least 90% of the focused bright spot intensity or total beam output, compared to a standard quartz high intensity discharge automotive headlamp according to European ECE Regulation 99, Lamp Model No. D2 having nominal dimensions of 2.6 mm inner diameter, 1.8 mm wall thickness and 4.2 mm arc gap.

6. A reflector lamp comprising the arctube of claim 1 and a reflector.

7. A ceramic arctube for use in a high intensity discharge lamp, said arctube comprising a ceramic light transmitting tube and a pair of spaced apart electrodes, said ceramic light transmitting tube being made of a highly dense, generally isotropic polycrystalline ceramic, said ceramic light transmitting tube having two or more features selected from the group consisting of (a) an inner diameter less than 2.6 mm, (b) a wall thickness of less than 1.4 mm, (c) real in-line transmission (RIT) greater than 20%, and (d) an inner surface or outer surface having an Ra value less than 100 nm.

8. The arctube of claim 7, said ceramic light transmitting tube being made of YAG, yttria, spinel or AlON.

9. The arctube of claim 7, said light transmitting tube having 3 or more features selected from said group.

10. The arctube of claim 7, said light transmitting tube having all 4 features of said group.

11. A ceramic arctube for use in a high intensity discharge lamp, said arctube comprising a ceramic light transmitting tube and a pair of spaced apart electrodes, said ceramic light transmitting tube having two or more features selected from the group consisting of (a) an inner diameter less than 2.6 mm, (b) a wall thickness of less than 1.4 mm, and (c) an inner surface or outer surface having an Ra value less than 100 nm.

12. The arctube of claim 11, said ceramic light transmitting tube being a single crystal ceramic light transmitting tube.

13. The arctube of claim 12, wherein said single crystal ceramic is sapphire or single crystal YAG.

14. The arctube of claim 11, said light transmitting tube having all 3 features of said group.
